(19) United States
(12) Patent Application Publication
(10) Pub. No.: US 2024/0166062 A1
(43) Pub. Date: May 23, 2024

(54) LIVE OBJECT PROTECTION AND METAL OBJECT DETECTION FOR ELECTRIC VEHICLE (EV) WIRELESS CHARGING

(71) Applicants: Hyundai Motor Company, Seoul (KR); Kia Corporation, Seoul (KR)

(72) Inventor: Rakan Chabaan, Farmington Hills, MI (US)

(21) Appl. No.: 17/992,265

(22) Filed: Nov. 22, 2022

(51) Int. Cl. B60L 53/124; H02J 50/12; H02J 50/40; H02J 50/60

(52) U.S. Cl. CPC B60L 53/124; H02J 50/12; H02J 50/402; H02J 50/60

(57) ABSTRACT

A combined metal object detection (MOD) and live object detection (LOD) system for a wireless power transfer (WPT) system in an electric vehicle (EV) charging application, and methods for use, are provided. The combined MOD and LOD system may comprise a transmitting pad, a detection coil pad coupled to the transmitting pad, and a receiving pad positioned adjacent to the transmitting pad. The transmitting pad, the detection coil pad, and the receiving pad may be configured such that, when a living object or a metal object appears between the transmitting pad and the receiving pad, an inductance or capacitance value change of the detection coil pad occurs.

### BACKGROUND

### Technical Field

Embodiments of the present disclosure relate to live object detection (LOD) and metal object detection (MOD) and, in particular, to a combination system of both metal MOD and LOD, configured to detect the metal object as well as living objects that appear between charging pads in order to ensure the safe operation of a wireless power transfer (WPT) system charging an electric vehicle (EV).

### Background

Wireless power transfer (WPT) technology has been widely used in applications such as consumer electronics, implantable medical devices, electric vehicles (EVs), etc., because of convenience and safety issues.

In a WPT system for an EV application, a transmitting coil is buried underground while the receiving coil is installed beneath the EV's chassis. During the charging process, the transmitting coil is excited by a high-frequency inverter. Then, a high-frequency AC magnetic field is generated and coupled with the receiving coil. Thus, power can be transferred to the EV via the magnetic coupling.

Although the magnetic filed outside the charging pads is reduced because ferrite plates and aluminum plates are adopted behind the charging coils, the magnetic density between the transmitting and receiving coils is still strong. If a metal object such as a key or a coil falls on the charging pads, the metal object will get heated because of an eddy current generated in it, which is dangerous and may cause fire. Moreover, the high-density AC magnetic field will threaten the health and life of a living object that enters into the charging zone by mistake during the charging process. Thus, not only metal object detection (MOD), but also live object detection (LOD), is necessary for WPT systems used in EV applications.

However, most of the existing technologies only focus on the MOD technology, and the LOD is not well studied and applied.

Generally, sensors such as thermal cameras, radar, pressure sensors, etc., are used to detect foreign objects. But these known sensors will increase system costs. Moreover, the detection results are not satisfactory because some objects that have no influence on the WPT system, such as, e.g., glass, will also be detected when using pressure sensors.

Additionally, some existing technologies have adopted additional coils in order to detect metal objects. However, the coils are placed on the same layer, which inevitably results in blind spots on the detection area. This means that the metal objects are difficult to be detected if they are placed on the blind spots. Thus, the detection accuracy is low.

Most of the existing technologies only focus on MOD. However, LOD is also important to ensure safe power transfer. The MOD method by using detection coils fails to detect living object, which is a problem.

For at least these reasons, a combination system of both MOD and LOD is needed, which may be configured to detect the metal object as well as living objects that appear between the charging pads in order to ensure the safe operation of the WPT system charging the EV.

### SUMMARY

According to an object of the present disclosure, a combined metal object detection (MOD) and live object detection (LOD) system for a wireless power transfer (WPT) system in an electric vehicle (EV) charging application is provided. The combined MOD and LOD system may comprise a transmitting pad, a detection coil pad coupled to the transmitting pad, and a receiving pad positioned adjacent to the transmitting pad. The transmitting pad, the detection coil pad, and the receiving pad may be configured such that, when a living object or a metal object appears between the transmitting pad and the receiving pad, an inductance or capacitance value change of the detection coil pad occurs.

According to an exemplary embodiment, the combined MOD and LOD system may further comprise a resonant circuit coupled to the detection coil pad. The resonant circuit may be configured such that the inductance or capacitance change causes a resonant condition of the resonant circuit to change.

According to an exemplary embodiment, the resonant circuit may be configured to generate an output, and may be configured such that the inductance or capacitance change causes the output of the resonant circuit to change.

According to an exemplary embodiment, the MOD and LOD system may further comprise a signal processing circuit configured to remove a noise signal from the output of the resonant circuit.

According to an exemplary embodiment, the output comprises an output voltage signal, and the output voltage signal may be configured such that it indicates whether a live object or a metal object is present between the transmitting pad and the receiving pad.

According to an exemplary embodiment, the combined MOD and LOD system may further comprise a plastic pad coupled to the detection coil pad.

According to an exemplary embodiment, the detection coil pad may comprise a plurality of detection coils.

According to an exemplary embodiment, when the living object appears between the transmitting pad and the receiving pad, the detection coil pad may be configured such that a parasitic capacitance between the plurality of detection coils occurs.

According to an exemplary embodiment, when a metal object appears between the transmitting pad and the receiving pad, the detection coil pad may be configured such that a change in a self-inductance of a detection coil of the detection coil pad occurs.

According to an exemplary embodiment, the detection coil pad comprises a four-layer coil structure.

According to an object of the present disclosure, a method for combined MOD and LOD for a WPT system in an EV charging application is provided. The method may comprise detecting, using a resonant circuit of a MOD and LOD system, an inductance or capacitance value change of a detection coil pad of the MOD and LOD system. The MOD and LOD system may comprise the resonant circuit, a transmitting pad, the detection coil pad coupled to the transmitting pad, and a receiving pad positioned adjacent to the transmitting pad. The transmitting pad, the detection coil pad, and the receiving pad may be configured such that, when a living object or a metal object appears between the transmitting pad and the receiving pad, the inductance or capacitance value change of the detection coil pad occurs.

According to an exemplary embodiment, the resonant circuit may be coupled to the detection coil pad, and the resonant circuit may be configured such that the inductance or capacitance change causes a resonant condition of the resonant circuit to change.

According to an exemplary embodiment, the method may further comprise generating, using the resonant circuit, an output. The inductance or capacitance change may cause the output of the resonant circuit to change.

According to an exemplary embodiment, the method may further comprise removing, using a signal processing circuit, a noise signal from the output of the resonant circuit.

According to an exemplary embodiment, the output may comprise an output voltage signal, and the output voltage signal may be configured such that it indicates whether a live object or a metal object is present between the transmitting pad and the receiving pad. The method may further comprise determining, using a processor, whether a live object or a metal object is present between the transmitting pad and the receiving pad based on the output voltage signal.

According to an exemplary embodiment, the detection coil pad may comprise a plurality of detection coils, and, when the living object appears between the transmitting pad and the receiving pad, the detection coil pad may be configured such that a parasitic capacitance between the plurality of detection coils occurs.

According to an exemplary embodiment, when a metal object appears between the transmitting pad and the receiving pad, the detection coil pad may be configured such that a change in a self-inductance of a detection coil of the detection coil pad occurs.

According to an object of the present disclosure, a combined MOD and LOD system for a WPT system in an EV charging application is provided. The combined MOD and LOD system may comprise a transmitting pad, a detection coil pad coupled to the transmitting pad, a receiving pad positioned adjacent to the transmitting pad, and a resonant circuit. The transmitting pad, the detection coil pad, and the receiving pad may be configured such that, when a living object or a metal object appears between the transmitting pad and the receiving pad, an inductance or capacitance value change of the detection coil pad occurs. The combined MOD and LOD system may further comprise a computing device, comprising a processor and a memory, configured to store programming instructions that, when executed by the processor, cause the processor to detect, using the resonant circuit, an inductance or capacitance value change of the detection coil pad.

According to an exemplary embodiment, the programming instructions may be further configured to cause the processor to generate, using the resonant circuit, an output. The inductance or capacitance change may cause the output of the resonant circuit to change.

According to an exemplary embodiment, the output may comprise an output voltage signal, and the output voltage signal may configured such that it indicates whether a live object or a metal object is present between the transmitting pad and the receiving pad. The programming instructions may be further configured to cause the processor to determine whether a live object or a metal object is present between the transmitting pad and the receiving pad based on the output voltage signal.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a combined metal object detection (MOD) and live object detection (LOD) system for a wireless power transfer (WPT) system in an electric vehicle (EV) charging application, according to an exemplary embodiment;

FIG. 2 illustrates multi-layer detection coils, according to an exemplary embodiment;

FIG. 3 illustrates a top-side and front-side view of a detection coil of a first layer, according to an exemplary embodiment;

FIG. 4A illustrates a circuit model of the detection coils of FIG. 2;

FIG. 4B illustrates a transformation of the circuit model of FIG. 4A;

FIG. 5 illustrates a resonant circuit, according to an exemplary embodiment;

FIG. 6 illustrates a detection system with multiple detection coils, according to an exemplary embodiment;

FIG. 7 illustrates an overall circuit configuration of a MOD and LOD combined system, according to an exemplary embodiment; and

FIG. 8 illustrates example elements of a computing device, according to an exemplary embodiment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

According to an exemplary embodiment, a metal object detection (MOD) and live object detection (LOD) combined system for an electric vehicle (EV) wireless power transfer (WPT) system is described. A special detection coil is designed, which may be used to detect metal objects as well as living objects. When a metal object is placed on the detection coil, the self-inductance of the coil will vary and, when a living object appears on the detection coil, the parasitic capacitance between the detection coils will change. The inductance or capacitance variation may be transformed into voltage variation, which will indicate the existence of a metal and/or living object. According to an exemplary embodiment, a four-layer coil structure is designed for the detection system, which may eliminate blind spots and increase detection accuracy.

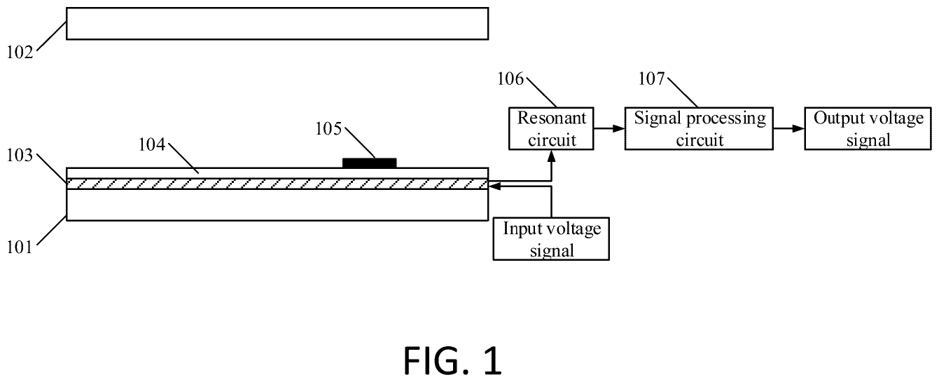

Referring now to FIG. 1, a combined MOD and LOD system for an WPT system in an EV charging application is illustratively depicted, according to an exemplary embodiment.

According to an exemplary embodiment, a detection coil pad 103 may be placed on a transmitting pad 101. A plastic pad 104 may be placed on the detection coil pad 103 for, e.g., protection.

When a living object or a metal object 105 appears between the transmitting pad 101 and a receiving pad 102, the inductance or capacitance value will change. Thus, the resonant condition of a resonant circuit 106 may be affected, and an output of the resonant circuit 106 may also vary.

A signal processing circuit 107 may be configured to remove a noise signal and the output may indicate whether there is a metal object and/or a living object on the transmitting pad. Thus, safety hazards caused by the metal and/or living objects may be avoided.

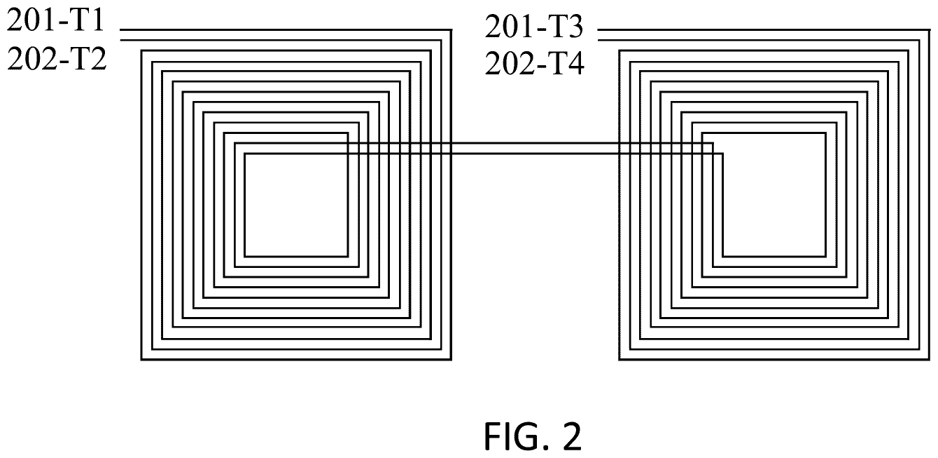

Referring now to FIG. 2, multi-layer detection coils 201, 202 are illustratively depicted, according to an exemplary embodiment of the present disclosure.

According to an exemplary embodiment, a detection coil pad 103 may consist of multi-layer detection coils. Each layer of the detection coils may be composed of a certain number of individual detection coils (e.g., detection coils 201 and 202 as shown in FIG. 2).

As shown in FIGS. 2, T1 and T3 are the two terminals of coil 201, while T2 and T4 are the two terminals of coil 202.

According to an exemplary embodiment, both coil 201 and coil 202 are bipolar coils, which comprise two small bipolar coils. The bipolar coils may be configured to reach decoupling with the main unipolar coil so that an influence of the main coil on the detection coil may be reduced.

A distance between detection coil 201 and detection coil 202 may be small, so that a parasitic capacitance between them may not be neglected. If a metal object is placed on the detection coil, the self-inductance of detection coil 201 and detection coil 202 may change. If a living object appears on the detection coil, the parasitic capacitance of detection coil 201 and detection coil 202 may also change. The inductance or capacitance variation may be used to detect a metal or living object, respectively.

According to an exemplary embodiment, the detection coils (e.g., detection coils 201 and 202) may have a four-layer structure. The four-layer structure may cover the whole transmitting pad 101.

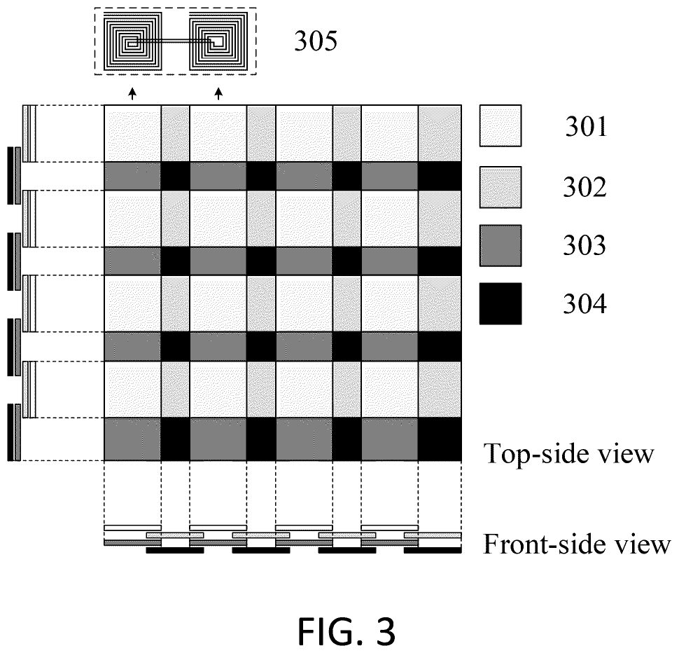

Referring now to FIG. 3, illustrates a top-side and front-side view of a detection coil of a first layer are illustratively depicted, according to an exemplary embodiment of the present disclosure.

The gap between the individual detection coils of one-layer and the edge of the individual detection coil may be covered by the detection coils of the other layers. Therefore, blind spots may be eliminated according to the systems and methods of the present disclosure. For example, metal or living objects 105 that are placed on any area of the transmitting pad may be detected. According to an exemplary embodiment, detection accuracy of the present disclosure environment may be improved.

301, 302, 303 and 304 indicate the first, second, third and fourth layer, respectively. FIG. 3 illustrates both the top-side and front-side view of the detection coil structure. 305 is a left-top corner of the detection coil on the first layer 301. According to an exemplary embodiment, the detection coil of FIG. 3 is a same detection coil from FIG. 2.

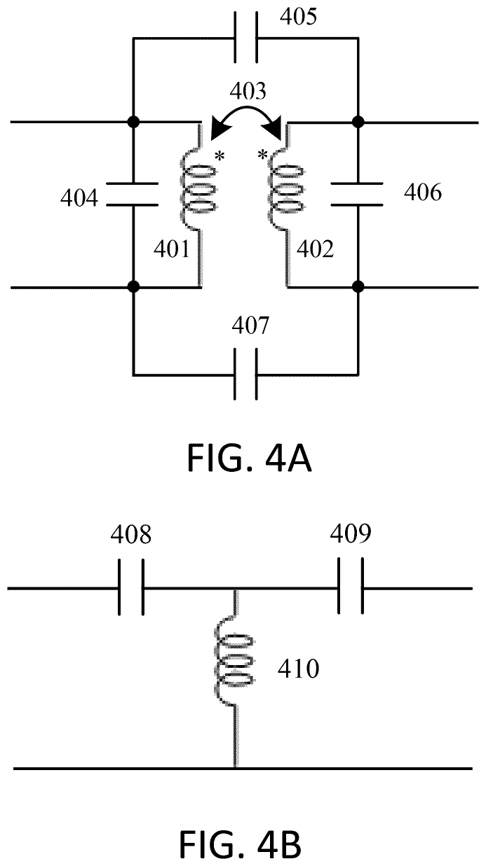

Referring now to FIGS. 4A and 4B, a circuit model (FIG. 4A) of the detection coils 201, 202 in FIG. 2, and a transformation thereof (FIG. 4B), are illustratively depicted, according to an exemplary embodiment of the present disclosure.

According to an exemplary embodiment, 401 and 402 are equivalent inductances of detection coil 201 and detection coil 202, respectively. 403 is the mutual inductance between inductances 401 and 402. According to an exemplary embodiment, 404, 405, 406, and 407 are parasitic capacitances between different coils.

According to an exemplary embodiment, the circuit model in FIG. 4A may be transformed into FIG. 4B.

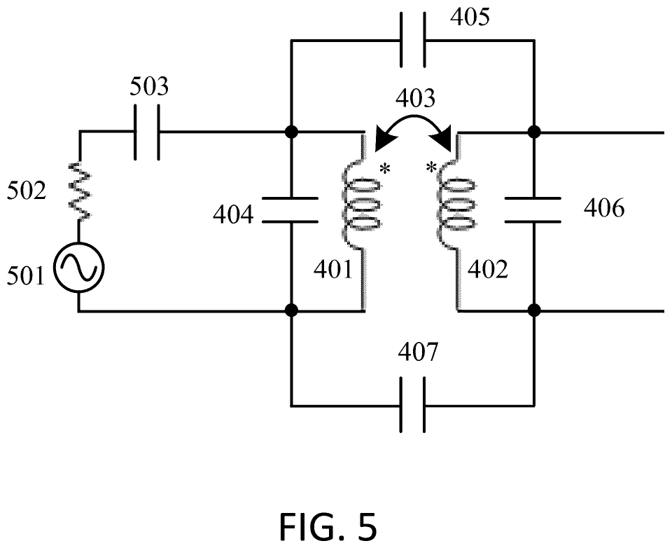

Referring now to FIG. 5, a resonant circuit is illustratively depicted, according to an exemplary embodiment of the present disclosure.

In order to amplify an output variation when a metal or living object 105 is placed on a detection coil, a resonant circuit may be designed (e.g., as shown in FIG. 5).

According to an exemplary embodiment, 501 is a high frequency power source configured to excite detection coil. According to an exemplary embodiment, 502 is an internal resistance of the power source. According to an exemplary embodiment, 503 is a resonant capacitor that is connected in series with the detection coil.

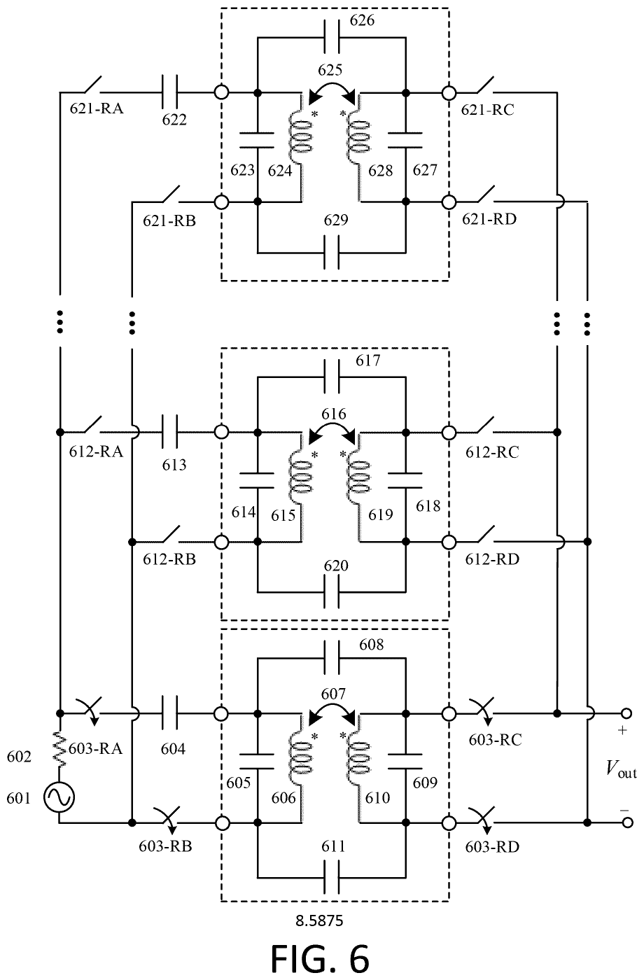

Referring now to FIG. 6, a detection system with multiple detection coils is illustratively depicted, according to an exemplary embodiment of the present disclosure.

According to an exemplary embodiment, 601 is a high frequency power source configured to excite a detection coil, and 602 is an internal resistance of the power source 601.

According to an exemplary embodiment, all the detection coils may be configured to share a same high frequency power source 601. The outputs of the detection coil may also be connected in parallel.

According to an exemplary embodiment, each detection coil has four relays (e.g., 603-RA, 603-RB, 603-RC, and 603-RD for the bottom detection coil; 612-RA, 612-RB, 612-RC, and 612-RD for the middle detection coil; and 621-RA, 621-RB, 621-RC, and 621-RD for the top detection coil).

According to an exemplary embodiment, for the bottom detection coil, 606 and 610 are equivalent inductances, 607 is the mutual inductance between inductances 606 and 610, and 605, 608, 609, and 611 are parasitic capacitances between different coils.

According to an exemplary embodiment, for the middle detection coil, 615 and 619 are equivalent inductances, 616 is the mutual inductance between inductances 615 and 619, and 614, 617, 618, and 620 are parasitic capacitances between different coils.

According to an exemplary embodiment, for the top detection coil, 624 and 628 are equivalent inductances, 626 is the mutual inductance between inductances 624 and 628, and 623, 626, 627, and 629 are parasitic capacitances between different coils.

At one moment the relays in a detection coil are closed while other relays are open, so that only this detection coil is connected to the power source via the series-connected resonant capacitor 604, 613, 622, while other detection coils are disconnected. By controlling the relays time-divisionally, all the detection coils may be measured to find the metal or living object.

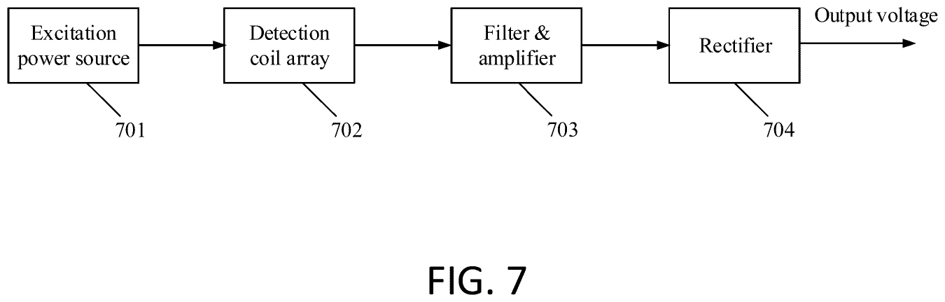

Referring now to FIG. 7, an overall circuit configuration of a MOD and LOD combined system is illustratively depicted, according to an exemplary embodiment of the present disclosure.

According to an exemplary embodiment, 701 is a high frequency power source configured to excite a detection coil array 702. The detection coils may be switched on, one by one, so that the output voltage will vary if any metal object or living object exists on the detection coil. After application of the filter and amplifier 703, the noise may be removed. The rectifier 704 may used to get a DC voltage signal from the AC signal. Then, the output voltage may indicate whether a metal or living object exists.

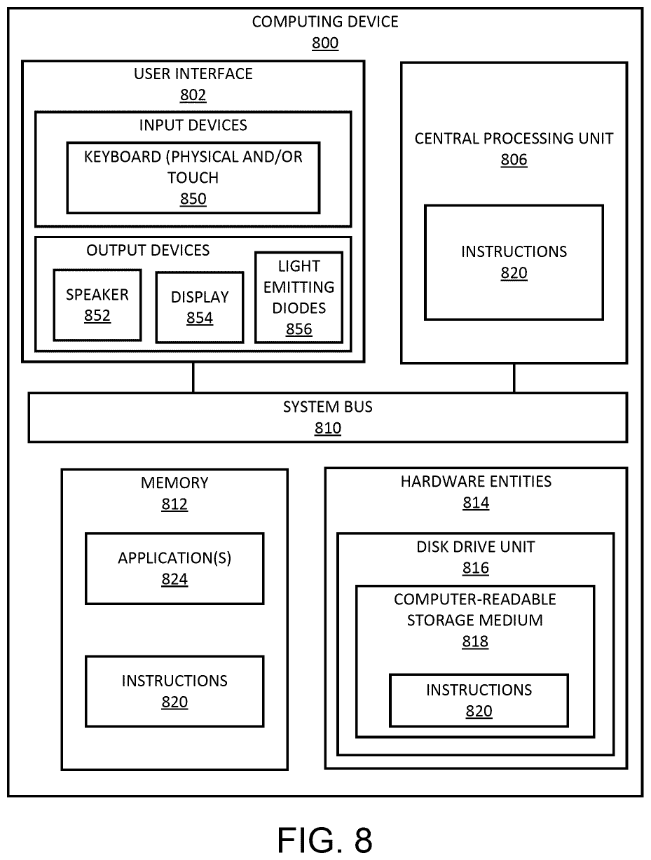

Referring now to FIG. 8, an illustration of an example architecture for a computing device 800 is provided. According to an exemplary embodiment, one or more functions of the systems of the present disclosure may be implemented by a computing device such as, e.g., computing device 800 or a computing device similar to computing device 800.

Computing device 800 may comprise more or less components than those shown in FIGS. 1-7. The hardware architecture of FIG. 8 represents one example implementation of a representative computing device configured to one or more methods and means for performing MOD or LOD in a WPT system charging an EV, as described herein. As such, the computing device 800 of FIG. 8 implements at least a portion of the method(s) described herein.

Some or all components of the computing device 800 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 8, the computing device 800 may comprise a user interface 802, a Central Processing Unit (“CPU”) 806, a system bus 810, a memory 812 connected to and accessible by other portions of computing device 800 through system bus 810, and hardware entities 814 connected to system bus 810. The user interface may comprise input devices and output devices, which may be configured to facilitate user-software interactions for controlling operations of the computing device 800. The input devices may comprise, but are not limited to, a physical and/or touch keyboard 850. The input devices may be connected to the computing device 800 via a wired or wireless connection (e.g., a Bluetooth® connection). The output devices may comprise, but are not limited to, a speaker 852, a display 854, and/or light emitting diodes 856.

At least some of the hardware entities 814 may be configured to perform actions involving access to and use of memory 812, which may be a Random Access Memory (RAM), a disk driver and/or a Compact Disc Read Only Memory (CD-ROM), among other suitable memory types. Hardware entities 814 may comprise a disk drive unit 816 comprising a computer-readable storage medium 818 on which may be stored one or more sets of instructions 820 (e.g., programming instructions such as, but not limited to, software code) configured to implement one or more of the methodologies, procedures, or functions described herein. The instructions 820 may also reside, completely or at least partially, within the memory 812 and/or within the CPU 806 during execution thereof by the computing device 800.

The memory 812 and the CPU 806 may also constitute machine-readable media. The term “machine-readable media”, as used here, refers to a single medium or multiple media (e.g., a centralized or distributed database, and/or associated caches and servers) that store the one or more sets of instructions 820. The term “machine-readable media”, as used here, also refers to any medium that is capable of storing, encoding or carrying a set of instructions 820 for execution by the computing device 800 and that cause the computing device 800 to perform any one or more of the methodologies of the present disclosure.

While the present disclosure has been described in connection with what is presently considered to be practical embodiments, it is to be understood that the present disclosure is not limited to the disclosed embodiments. On the contrary, it is intended to cover various modifications and equivalent arrangements included within the spirit and scope of the appended claims.

What is claimed is:

1. A combined metal object detection (MOD) and live object detection (LOD) system for a wireless power transfer (WPT) system in an electric vehicle (EV) charging application, the combined MOD and LOD system comprising:
a transmitting pad;
a detection coil pad coupled to the transmitting pad; and
a receiving pad positioned adjacent to the transmitting pad,
wherein the transmitting pad, the detection coil pad, and the receiving pad are configured such that, when a living object or a metal object appears between the transmitting pad and the receiving pad, an inductance or capacitance value change of the detection coil pad occurs.

2. The combined MOD and LOD system of claim 1, further comprising a resonant circuit coupled to the detection coil pad,
wherein the resonant circuit is configured such that the inductance or capacitance change causes a resonant condition of the resonant circuit to change.

3. The combined MOD and LOD system of claim 2, wherein the resonant circuit is configured:
to generate an output; and
such that the inductance or capacitance change causes the output of the resonant circuit to change.

4. The combined MOD and LOD system of claim 3, further comprising a signal processing circuit configured to remove a noise signal from the output of the resonant circuit.

5. The combined MOD and LOD system of claim 3, wherein:
the output comprises an output voltage signal; and
the output voltage signal is configured such that it indicates whether a live object or a metal object is present between the transmitting pad and the receiving pad.

6. The combined MOD and LOD system of claim 1, further comprising a plastic pad coupled to the detection coil pad.

7. The combined MOD and LOD system of claim 1, wherein the detection coil pad comprises a plurality of detection coils.

8. The combined MOD and LOD system of claim 7, wherein, when the living object appears between the transmitting pad and the receiving pad, the detection coil pad is configured such that a parasitic capacitance between the plurality of detection coils occurs.

9. The combined MOD and LOD system of claim 1, wherein, when a metal object appears between the transmitting pad and the receiving pad, the detection coil pad is configured such that a change in a self-inductance of a detection coil of the detection coil pad occurs.

10. The combined MOD and LOD system of claim 1, wherein the detection coil pad comprises a four-layer coil structure.

11. A method for combined metal object detection (MOD) and live object detection (LOD) for a wireless power transfer (WPT) system in an electric vehicle (EV) charging application, the method comprising:
detecting, using a resonant circuit of a MOD and LOD system, an inductance or capacitance value change of a detection coil pad of the MOD and LOD system,
wherein the MOD and LOD system comprises:
the resonant circuit;
a transmitting pad;
the detection coil pad coupled to the transmitting pad; and
a receiving pad positioned adjacent to the transmitting pad,
wherein the transmitting pad, the detection coil pad, and the receiving pad are configured such that, when a living object or a metal object appears between the transmitting pad and the receiving pad, the inductance or capacitance value change of the detection coil pad occurs.

12. The method of claim 11, wherein:
the resonant circuit is coupled to the detection coil pad, and
the resonant circuit is configured such that the inductance or capacitance change causes a resonant condition of the resonant circuit to change.

13. The method of claim 12, further comprising generating, using the resonant circuit, an output,
wherein the inductance or capacitance change causes the output of the resonant circuit to change.

14. The method of claim 13, further comprising removing, using a signal processing circuit, a noise signal from the output of the resonant circuit.

15. The method of claim 13, wherein:
the output comprises an output voltage signal, and
the output voltage signal is configured such that it indicates whether a live object or a metal object is present between the transmitting pad and the receiving pad, and
further comprising determining, using a processor, whether a live object or a metal object is present between the transmitting pad and the receiving pad based on the output voltage signal.

16. The method of claim 11, wherein:
the detection coil pad comprises a plurality of detection coils, and
when the living object appears between the transmitting pad and the receiving pad, the detection coil pad is configured such that a parasitic capacitance between the plurality of detection coils occurs.

17. The method of claim 11, wherein, when a metal object appears between the transmitting pad and the receiving pad, the detection coil pad is configured such that a change in a self-inductance of a detection coil of the detection coil pad occurs.

18. A combined metal object detection (MOD) and live object detection (LOD) system for a wireless power transfer (WPT) system in an electric vehicle (EV) charging application, the combined MOD and LOD system comprising:
a transmitting pad;
a detection coil pad coupled to the transmitting pad;
a receiving pad positioned adjacent to the transmitting pad;
a resonant circuit,
wherein the transmitting pad, the detection coil pad, and the receiving pad are configured such that, when a living object or a metal object appears between the transmitting pad and the receiving pad, an inductance or capacitance value change of the detection coil pad occurs; and
a computing device, comprising a processor and a memory, configured to store programming instructions that, when executed by the processor, cause the processor to detect, using the resonant circuit, an inductance or capacitance value change of the detection coil pad.

19. The combined MOD and LOD system of claim 18, wherein the programming instructions are further configured to cause the processor to generate, using the resonant circuit, an output,
wherein the inductance or capacitance change causes the output of the resonant circuit to change.

20. The combined MOD and LOD system of claim 19, wherein:
the output comprises an output voltage signal,
the output voltage signal is configured such that it indicates whether a live object or a metal object is present between the transmitting pad and the receiving pad, and
the programming instructions are further configured to cause the processor to determine whether a live object or a metal object is present between the transmitting pad and the receiving pad based on the output voltage signal.
